(19) United States
(12) Patent Application Publication
(10) Pub. No.: US 2007/0140949 A1
(43) Pub. Date: Jun. 21, 2007

(54) Extraction of peroxide treated petroleum streams

(76) Inventors: Thomas R. Palmer, Baton Rouge, LA (US); William J. Murphy, Baton Rouge, LA (US)

Correspondence Address: ExxonMobil Research & Engineering Company, P.O. Box 900, 1545 Route 22 East, Annandale, NJ, 08801-0900, US

(21) Appl. No.: 11/303,512

(22) Filed: Dec. 16, 2005

(51) Int. Cl. C01B 15/00

(52) U.S. Cl. 423/582; 423/584

(57) ABSTRACT

This invention relates to a method for generating peroxides in petroleum streams and extracting oxidized sulfur and nitrogen compounds. Peroxides are generated in-situ by combining the petroleum stream with a high neutralization number (HNN) crude and adding an oxygen-containing stream. Alternatively, the oxidation of sulfur and nitrogen compounds may be accomplished by adding peroxides in the presence of oil soluble metal catalysts. The peroxides oxidize nitrogen and sulfur compounds in the petroleum stream to more polar compounds which are solvent extracted.

### FIELD OF THE INVENTION

This invention relates to a method for generating peroxides in petroleum streams and extracting oxidized sulfur and nitrogen compounds. More particularly, peroxides are generated in-situ by combining the petroleum stream with a high neutralization number (HNN) crude and adding an oxygen-containing stream. HNN crudes contain molecules sufficient for peroxide generation. Alternatively, the oxidation of sulfur and nitrogen compounds may be accomplished by adding peroxides in the presence of oil soluble metal catalysts. The peroxides oxidize nitrogen and sulfur compounds in the petroleum stream to more polar compounds which are solvent extracted

### BACKGROUND OF THE INVENTION

Opportunity crudes are crudes that present some difficulties to the refiner and are therefore sold at discount. These crudes may, for example, present corrosion problems because they have high levels of naphthenic acids. Another property of HNN crudes is their elevated levels of large multi-ring naphthene and naphtheno-aromatic molecules. Examples of HNN crudes are Gryphon or Heidrun crude with TAN (total acid number) values of 3.9 and 2.5, respectively. Examples of non-HNN crudes would include Arab Light with a TAN of 0.12 and Olmeca with a TAN of 0.10. However, the supply of such HNN crudes is likely to increase as compared to other low acid crudes. Many strategies have been proposed to deal with acid crudes including corrosion resistant metals, corrosion inhibitors and process modifications.

Almost all crudes contain contaminants that must be removed. The conventional method for removing sulfur (HDS) and nitrogen (HDN) contaminants from lubricant feedstocks in large integrated refineries involves hydrotreating over hydrotreating catalysts. Although hydrotreaters involve an up-front capital expense, hydrotreaters are effective and operational considerations make them a viable economic alternative for removing sulfur and nitrogen contaminants.

Some refineries use solvent refining techniques to produce lubricant basestocks. Solvent refining techniques use solvents to separate a more paraffinic raffinate from a more aromatic extract. As many sulfur and nitrogen contaminants occur in aromatic compounds, they tend to accumulate in the aromatic extract. Solvent refining techniques alone are limited in the economic production of basestocks having a VI greater than about 105. The ever increasing performance standards for modern automobile engines are resulting in demands for basestocks with higher VI. Thus many original equipment manufacturers specify that lubricating oils meet Group II requirements (90+% saturates, <0.03% sulfur, 80-119 VI) and the trend is to even higher basestock qualities of Group III (90+saturates, <0.03% sulfur and 120+VI). In order to meet Group II standards, solvent extraction has been combined with hydrotreating wherein hydrotreating is used to boost the VI of the raffinate.

Another approach to remove sulfur and nitrogen contaminants is the use of chemical oxidants to convert the sulfur and nitrogen compounds to more polar oxidized species such as sulfoxides, sulfones, nitro compounds, nitroso compounds or amine oxides. The most commonly used oxidant is peroxide based, including for example, inorganic and organic peroxy acids and hydrogen peroxide. The chemical oxidant may be combined with a catalyst to further reduce nitrogen and sulfur contaminants.

Peroxides have also been added to fuels for producing oxygenated components, which components impart beneficial properties to the fuels. Peroxides are, however, relatively expensive and may raise operational concerns.

It would be desirable to have an improved solvent extraction process in which sulfur and/or nitrogen containing contaminants are more effectively separated.

### SUMMARY OF THE INVENTION

One embodiment of the invention relates to an in-situ method for generating peroxides in crudes or distillates containing sulfur and nitrogen compounds and solvent extracting oxidized sulfur and nitrogen compounds which comprises: (a) mixing the crude or distillate with a high neutralization number crude having a total acid number (TAN) greater than 1.0 to produce a mixture of crude or distillate and high neutralization crude, (b) adding an oxygen-containing gas to the mixture from step (a) for a time sufficient to generate peroxides in a concentration of at least about 1 wt. %, based on mixture, (c) oxidizing the sulfur and nitrogen compounds and (d) solvent extracting oxidized sulfur and nitrogen compounds.

Another embodiment of the invention relates to an in-situ method for generating peroxides in crudes or distillates containing sulfur and nitrogen compounds and solvent extracting oxidized sulfur and nitrogen compounds which comprises: (a) combining the crude or distillate with a high neutralization number crude having a total acid number (TAN) greater than 1.0, (b) adding an oil soluble metal catalyst to produce a mixture of crude or distillate, high neutralization crude and oil soluble metal catalyst, (c) adding an oxygen-containing gas to the mixture from step (b), (d) oxidizing the sulfur and nitrogen compounds and (e) solvent extracting oxidized sulfur and nitrogen compounds.

Another embodiment relates to a method for generating peroxides in crudes or distillates containing sulfur and nitrogen compounds and solvent extracting oxidized sulfur and nitrogen compounds which comprises: combining the crude or distillate with an oil soluble metal catalyst to produce a mixture of crude or distillate and oil soluble metal catalyst, (b) adding a peroxide to the mixture, (c) oxidizing the sulfur and nitrogen compounds and (d) solvent extracting oxidized sulfur and nitrogen compounds.

### BRIEF DESCRIPTION OF THE DRAWINGS

FIG. 1 shows the FTIR subtraction spectra of four sequential samples undergoing oxidation across a wavelength ranging from 600 to 2000 cm⁻¹.

FIG. 2 shows FTIR subtraction spectra of four sequential samples undergoing oxidation reactions generally associated with the region where oxidation products are measured.

### DETAILED DESCRIPTION OF THE INVENTION

Crude oils and distillate fractions that are considered corrosive generally contain organic acids. The organic acids most commonly associated with acidic properties are naphthenic acids. The acidity of a crude or distillate is normally measured as the Total Acid Number or TAN. The TAN is measured by standard ASTM methods such as D-664 and is expressed as the number of milligrams of KOH needed to neutralize one gram of oil. Crudes and distillates with TAN values below 0.5 are considered non-corrosive, those with TAN values between 0.5 and 1.0 are considered moderately corrosive and those with TAN values above 1.0 are considered corrosive. These corrosive crudes are known as High Neutralization Number crudes or “HNN” crudes. Suitable feeds for mixing with HNN crudes include crudes having a TAN less than 1.0, reduced crudes, raffinates, hydrotreated oils, hydrocrackates, atmospheric gas oils, vacuum gas oils, coker gas oils, atmospheric and vacuum resids, deasphalted oils, slack waxes and Fischer-Tropsch wax. Such feeds may be derived from distillation towers (atmospheric and vacuum), hydrotreaters and solvent extraction units, and may have wax contents of up to 50% or more. Both the HNN crudes and the feeds mixed with HNN crudes normally contain sulfur and nitrogen compounds as contaminants. Sulfur compounds are present in amounts up to 30000 wppm or more, based on total feed and nitrogen compounds up to 3000 wppm or more. HNN crudes and distillates derived therefrom are not typically used for the production of lubricant basestocks because of their inherent instability to oxidation. These crudes contain multi-ring naphthenes and naphtheno-aromatic compounds that are easily oxidized because they have exposed tertiary hydrogens that are readily susceptible to oxidation. It is this oxidation instability which has been used to advantage in the instant process.

In the present process, the multi-ring naphthenes and naphtheno-aromatic compounds in HNN crudes and distillates are oxidized by exposing these compounds to an oxidizing medium to form in-situ generated hydroperoxides. An example of such a reaction is as follows:

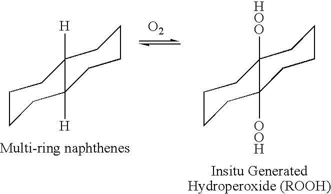

Naphthenes are cycloparaffins having one or more cyclic rings. The rings may have 5 or more carbon atoms and may be substituted with substituents such as alkyl groups. Examples of one ring naphthenes include cyclopentane, cyclohexane, cyclooctane, methyl cyclohexane, ethyl cyclohexane, and the like. Naphthenes may also be polycyclic, i.e., containing multiple rings. Heavier petroleum fractions commonly include polycyclic naphthenes containing 2, 3, 4, 5 or more cyclic rings which may be fused. The cyclic rings may contain 5 or more carbon atoms and may bear substituents such as alkyl groups. The polycyclic naphthenes may also be bridged. Naphtheno-aromatics are fused polycyclic hydrocarbons containing both aromatic and naphthene ring systems. The fused ring systems may contain 2 or more rings and the rings may contain 5 or more carbon atoms. Preferred naphthens and naphtheno-aromatics contain 2 or more rings which may be substituted with alkyl. Examples include decalin, adamantane, cholestane, tetralin, norborane, 3-methyl-1,2-cyclopentenophenanthrene, 1,2,3,4-tetrahydrophenanthrene, indane, perhydroanthracene, perhydrofluorene and perhydroterphenyl.

The amount of HNN crudes that are mixed with other crudes, distillates or mixtures thereof range from 10 to 100 wt. %, based on total mixture of HNN crude and other crude or distillate, preferably 30 to 100 wt. %. The mixing of HNN crudes with other petroleum crudes and distillates occurs at temperatures greater than about 50° C.

The oxidizing medium is preferably an oxygen-containing gas, more preferably oxygen, most preferably air. Ozone may also be used as an oxidizing medium. The oxidizing medium may be mixed with other non-oxidizing gases or may be mixed with inert solvent. In order to form in-situ hydroperoxides, an oxygen-containing gas is added to the mixture by any conventional means for mixing gases and liquids. Oxygen-containing gas is added for a time sufficient to form hydroperoxides.

The oxygen-containing gas may be added by conventional means such as frits, spargers, bubbles and the like, or may be added under pressure to a vessel containing the HNN mixture and allowed to diffuse into HNN mixture. The conditions for adding oxygen-containing gas include temperatures from ambient to 700° C., pressures from atmospheric to 34576 kPa (5000 psig), and treat gas rates up to 534 m³/m³ (3000 scf/B). The oxygen-containing gas is added to the mixture for a time sufficient to generate peroxides in a concentration of at least about 1 wt. %, based on mixture. The oxygen-containing gas is preferably added to the mixture for a time sufficient to generate peroxides in a concentration of at least about 1 wt. %, based on mixture.

In another embodiment, oil soluble catalysts may be added to the HNN mixture. Oil soluble metal catalysts include metals from Groups 4-12 of the Periodic Table based on the IUPAC format having Groups 1-18. Examples of metals include V, Cr, Mo, W, Fe, Ni, Co, Pt, Pd, Ru and Mn. The oil soluble metal catalysts include salts and compounds such as organic acids such as acyclic, alicyclic and aromatic carboxylates including carboxylates, sulfonates, naphthenates, chelates such as acetylacetonates, halides, sulfonates, organic amines, hetropolyacids and the like that render the metal oil soluble. Preferred oil soluble metal catalysts include metal naphthenates, metal acetates and metal beta diketonates. The oil soluble metal catalyst may also be combined with inert solvents, especially non-polar solvents such as hydrocarbons, e.g., mineral oils, turbine oils naphthenic oils, paraffinic oils, synthetic oils and the like. The metal concentrations are from 1 to 1000 wppm, based on crude or distillate plus HNN crude. Reaction temperatures may range from 50 to 250° C., preferably 100-160° C.

In another embodiment not involving the addition of HNN crudes, peroxides may be combined with crude and/or distillate containing oil soluble metal catalyst. In this embodiment, the peroxide may be added directly to the mixture of crude/distillate and oil soluble metal catalyst. Suitable peroxides include hydrogen peroxide, inorganic peroxide compounds, salts of peracids such as perborates, and organic peroxides such as benzoyl peroxide.

In an embodiment involving thermal cleavage, the in-situ generated peroxides oxidize sulfur, and under the reaction conditions, weaken the polar-hydrocarbon bonds. The oxidized sulfur compounds may be thermally treated to cleave the polar-hydrocarbon bonds producing hydrocarbons and sulfur dioxide. The oxidation mechanism and thermal cleavage is shown as the follow reaction mechanisms:

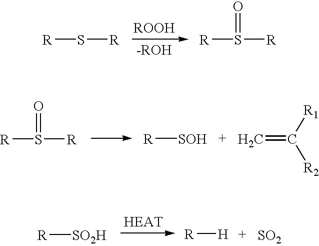

The sulfur can be present in a ring species or as aliphatic sulfur. This allows for a minimum of hydrocarbon loss during the desulfurization process. The temperature is that needed for thermal cleavage of the oxidized sulfur species to produce hydrocarbon and SO₂. This temperature will vary according to the particular oxidized sulfur species to be thermally cleaved.

The in-situ generated peroxides will oxidize nitrogen or sulfur compounds to more polar species that are more readily extracted by solvent extraction. The following reactions are used to illustrate the peroxide oxidation:

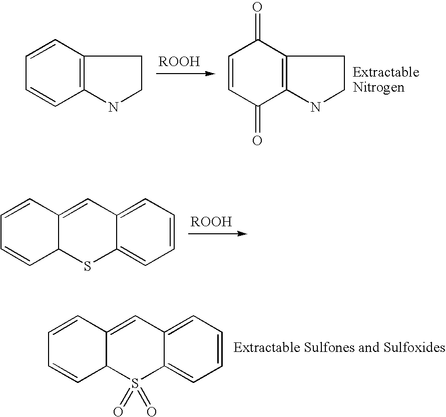

The oxidized sulfur and nitrogen compounds are then solvent extracted. If thermal cleavage is employed the oxidized sulfur compounds are those remaining after thermal cleavage. Solvent extraction is used to separate aromatic from paraffins, i.e., the raffinates are rich in paraffins while the extract is rich in aromatics. The nitrogen and sulfur compounds are oxidized to more polar species which makes them more readily separable by solvent extraction. Many nitrogen and sulfur heterocyclic compounds contain paraffinic side chains making the raffinate/extract separation otherwise more difficult. The nitrogen compounds appear as both basic and non-basic nitrogen species. Non-limiting examples of basic nitrogen species may include quinolines and substituted quinolines, and non-limiting examples of non-basic nitrogen species may include carbazoles and substituted carbazoles. Sulfur compounds include both non-heterocyclic species such as sulfides, polysulfides and mercaptans and heterocyclic species. Heterocyclic compounds include thiophene, thiophene derivatives, benzothiophene, and benzothiophene derivatives as well as mixed sulfur/nitrogen species such as thiazoles

The raffinates may be either fully or partially extracted, i.e. under-extracted. By under-extracted it is meant that the extraction is carried out under conditions such that the raffinate yield is maximized while still removing most of the lowest quality molecules from the feed. Raffinate yield may be maximized by controlling extraction conditions, for example, by lowering the solvent to oil treat ratio and/or decreasing the extraction temperature.

Raffinates and extracts can be produced under standard solvent extracting conditions. Typically, the solvent extracting process involves contacting a lube oil boiling range stream with an extraction solvent. The extraction solvent can be any solvent known that has an affinity for aromatic hydrocarbons in preference to non-aromatic hydrocarbons. Non-limiting examples of such solvents include sulfolane, furfural, phenol, and N-methyl pyrrolidone (“NMP”). Furfural, phenol, and NMP are preferred.

The feed stream to be extracted can be contacted with the extraction solvent by any suitable solvent extraction method. Non-limiting examples of such include batch, semi-batch, or continuous. It is preferred that the extraction process be a continuous process, and it is more preferred that the continuous process be operated in a counter-current fashion. In a counter-current configuration, it is preferred that the feedstream be introduced into the bottom of an elongated contacting zone or tower and caused to flow in an upward direction while the first extraction solvent is introduced at the top of the tower and allowed to flow in a downward direction, counter-current to the up-flowing feedstream. In this configuration, the feedstream is forced to pass counter-currently to the extraction solvent resulting in the intimate contact between the extraction solvent and the feedstream. The extraction solvent and the light lube stream migrate to opposite ends of the contacting zone.

The conditions under which the extraction solvent is contacted with the feedstream can be any conditions known to be effective in the solvent extraction of petroleum feedstreams. In a preferred embodiment, the temperature and pressure are selected to prevent complete miscibility of feedstream in the extraction solvent. Typical extraction process operating ranges for a treat tower with 10-20 trays include a tower bottoms temperatures from 50-100° C., tower temperature gradients from 10-30°, water in solvent concentration of less than 5%, and a down tower solvent treat between 100-300 vol % on feed. More preferably these conditions would be a tower bottoms temperature from 60-75° C., gradient of 10-20°, water in solvent from 1-2%, and a treat of 125-200 vol %.

The contacting of the feedstream with the extraction solvent produces at least a first aromatics-rich extract solution and a first aromatics-lean raffinate solution. It should be noted that as used herein, aromatics-lean is meant to refer to the concentration of aromatics present in the raffinate phase produced by solvent extraction in relation to the concentration of aromatics present in the extract phase produced by solvent extraction. The first aromatics-lean raffinate solution is then treated to remove at least a portion of the extraction solvent contained therein, thus producing the raffinate phase. The removal of at least a portion of the extraction solvent can be done by any means known in the art effective at separating at least a portion of an extraction solvent from an aromatics lean raffinate solution. Preferably the raffinate is produced by separating at least a portion of the first extraction solvent from the first aromatics-rich extract solution in a stripping or distillation tower. By at least a portion, it is meant that at least about 80 vol %, preferably about 90 vol %, more preferably 95 vol %, based on the first aromatics-lean raffinate solution, of the extraction solvent is removed from the aromatics-lean raffinate solution. Most preferably substantially all of the extraction solvent is removed from the aromatics-lean raffinate solution. It should be noted that when the solvent extracting method that produces the raffinate is referenced herein, it is meant to encompass this separation step.

The oxidation step using peroxide may precede or follow the extraction step. The reaction between peroxide and sulfur and/or nitrogen containing compounds takes place at temperatures ranging from 50-250° C. The reaction temperature and amount of peroxide will vary depending on the speed and extent of oxidation desired. The higher the temperature, the more rapid the oxidation may take place depending on the availability of oxygen for oxidizing the sulfur and nitrogen containing molecules. A preferred condition used approximately 10-15% peroxide with a reactor temperature between 120-160° C. The raffinate from the extraction step may be processed, typically by distillation, to recover solvent. The recovered solvent may then be recycled back to the extraction step.

This invention is further illustrated by the following example.

### EXAMPLE

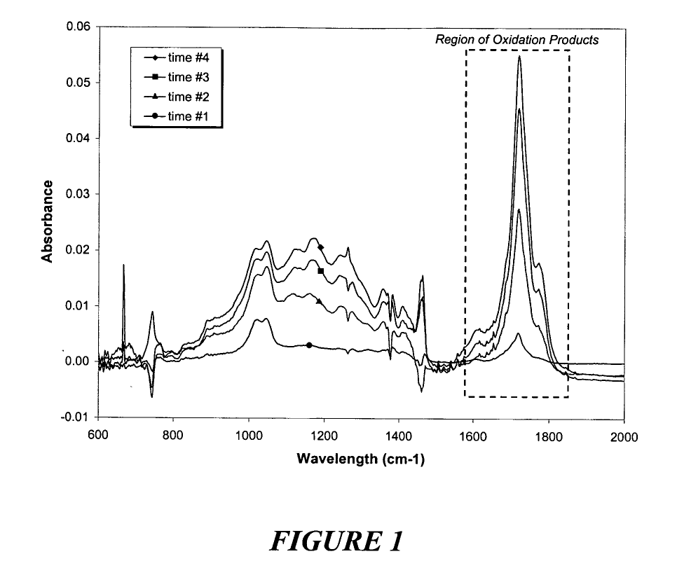

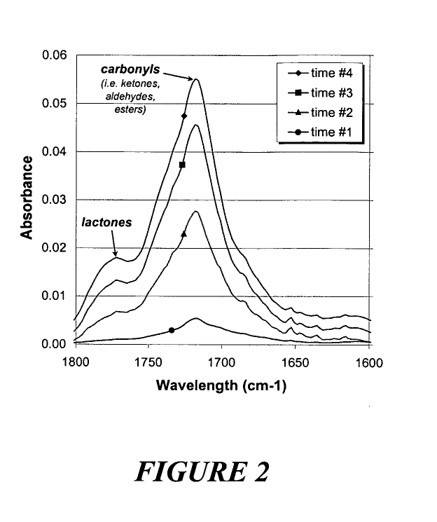

Experiments were conducted using a dewaxed HNN distillate as a test fluid and heated to 150° C. in the presence of air bubbling through the fluid. The oxidation products were measured by Fourier Transform Inferred Spectroscopy (FTIR) to determine the existence of oxidation products. Additionally, a sample was heated in the presence of a nitrogen gas instead of air to determine the effect of any thermal degradation of the fluid under these test conditions. This sample was also measured by FTIR and used as a baseline reading. A subtraction spectra was generated at four different times during the oxidation experiments using the FTIR readings minus the baseline reading. The results are given in FIGS. 1 and 2, where FIG. 1 shows the FTIR subtraction spectra of four sequential samples undergoing oxidation across a wavelength ranging from 600 to 2000 cm⁻¹. FIG. 2 shows FTIR subtraction spectra of four sequential samples undergoing oxidation reactions generally associated with the region where oxidation products are measured. The Figure shows a close-up of products FTIR subtraction spectra for the region of interest to determine oxidation products of four sequential samples undergoing oxidation reactions.

When examining the spectra generated from these samples, it is evident that there was an increase in the amount of oxidation products generated as the oxidation reaction proceeded, shown by the increase in the area under the peaks in the 1600-1800 cm⁻¹ region. Specifically, there are noticeable peaks present at 1773 representing carbonyls such as ketones, aldehydes, and esters, along with a peak at 1718 cm⁻¹ representing the presence of lactone carbonyls. This data provides proof that oxidation reactions occurred during the experiments. In order for the oxidation pathways necessary for these reactions to occur, an intermediate step must have existed in which peroxides or hydroperoxides were generated. An example reaction is provided below showing the pathway from a hydrocarbon to a ketone carbonyl.

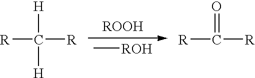

The following set of experimental runs compared a base case of a distillate undergoing extraction without the oxidation step (run 1 below). The experimental runs include:
1. the heating of the distillate followed by extraction,
2. the addition of an oil-soluble catalyst, air and heat without peroxides followed by extraction,
3. the formation of in-situ peroxides, addition of air and heat without the oil soluble catalyst followed by extraction,
4. the formation of in-situ peroxides, addition of oil soluble catalyst, air and heat followed by extraction,
5. the formation of in-situ peroxides, addition of hydrogen peroxide, oil soluble catalyst, air, and heat followed by extraction.

The results of these experiments have been shown in Table 1 as an improvement over the sulfur and nitrogen found in the feed distillate. The data shows that the use of peroxides and catalyst removed over 40% of the remaining sulfur and nitrogen that would have been present after extraction without the use of oxidation. Furthermore, the yield values were monitored to establish the maximum loss of hydrocarbon when using this technique. The method described showed no additional yield loss due to the oxidation process as compared to the non-oxidation process.

TABLE 1

| Experimental Run | Sulfur | Nitrogen |
|---|---|---|
| Base Case - No Oxidation | 67.0% | 85.0% |
| No Peroxides | 69.2% | 91.3% |
| In-Situ Peroxides & No Catalyst | 77.3% | 91.0% |
| In-Situ Peroxides & Oil Soluble | 84.3% | 93.0% |
| Catalyst | | |
| In-Situ & Added Peroxides & Oil | 97.5% | 93.6% |
| Soluble | | |

While not wishing to be bound by any particular theory, a contribution to the small hydrocarbon yield losses observed in the experiments is the oxidative reaction mechanism for the aliphatic sulfur compounds. The most important reaction to eliminate hydroperoxides is acid-catalyzed decomposition. The acids can be protic (RSO₂H) or Lewis acids (SO₂). Organo-sulfur compounds are the main source for the formation of the acid catalyst. Compounds such as organo-sulfides react with hydroperoxides to yield sulfoxides as key intermediates for the stabilization of lubricants.

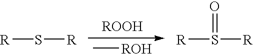

None the less these sulfoxides can undergo thermolytic cleavage leading to the formation of sulfenic acid (RSOH).

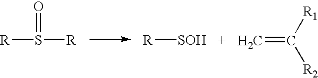

The structure of the group attached to the sulfur atom influences the activity of the rate of cleavage of the reaction. Further reaction of the sulfenic acid (RSOH) with hydroperoxide leads to the formation of sulfinic acid (R—SO₂H) which when heated decomposes to a hydrocarbon and sulfur dioxide.

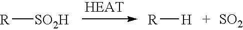

Sulfinic acids are the most important acid catalysts for ionic decompositions below 100° C. At higher temperatures SO₂ is a most efficient catalyst. Disulphides follow the same reaction pattern forming a thiosulfurous acid RS—SO₂H, which under higher temperatures and in the presence of hydroperoxide, is cleaved to give SO₂ and a sulfenic acid. This methodology explains the removal of the aliphatic sulfur, which was approximately 25% of the total sulfur, the rest was removed via solvent extraction.

1. An in-situ method for generating peroxides in crudes or distillates containing sulfur and nitrogen compounds and solvent extracting oxidized sulfur and nitrogen compounds which comprises: (a) combining the crude or distillate with a high neutralization number crude having a total acid number (TAN) greater than 1.0 to produce a mixture of crude or distillate and high neutralization crude, (b) adding an oxygen-containing gas to the mixture from step (a) for a time sufficient to generate peroxides in a concentration of at least about 1 wt. %, based on mixture, (c) oxidizing the sulfur and nitrogen compounds and (d) solvent extracting oxidized sulfur and nitrogen compounds under solvent extracting conditions.

2. An in-situ method for generating peroxides in crudes or distillates containing sulfur and nitrogen compounds and solvent extracting oxidized sulfur and nitrogen compounds which comprises: (a) combining the crude or distillate with a high neutralization number crude having a total acid number (TAN) greater than 1.0, (b) adding an oil soluble metal catalyst to produce a mixture of crude or distillate, high neutralization crude and oil soluble metal catalyst, (c) adding an oxygen-containing gas to the mixture from step (b), (d) oxidizing the sulfur and nitrogen compounds and (e) solvent extracting oxidized sulfur and nitrogen compounds under solvent extracting conditions.

3. A method for generating peroxides in crudes or distillates containing sulfur and nitrogen compounds and solvent extracting oxidized sulfur and nitrogen compounds which comprises: combining the crude or distillate with an oil soluble metal catalyst to produce a mixture of crude or distillate and oil soluble metal catalyst, (b) adding a peroxide to the mixture, (c) oxidizing the sulfur and nitrogen compounds and (d) solvent extracting oxidized sulfur and nitrogen compounds under solvent extracting conditions.

4. The process of claims 1 or 3 wherein oxidized sulfur compounds from step (c) are thermally decomposed.

5. The process of claim 2 wherein oxidized sulfur compounds from step (d) are thermally decomposed.

6. The process of claims 1 or 2 wherein the high neutralization number crude contains multi-ring naphthenes and naphtheno-aromatic compounds.

7. The process of claim 6 wherein the multi-ring naphthenes and naphtheno-aromatic compounds react with oxygen-containing gas to form peroxides.

8. The process of claims 1 or 2 wherein the amount of HNN crudes that are mixed with other crudes, distillates or mixtures thereof range from 10 to 100 wt. %, based on total mixture of HNN crude and other crude or distillate.

9. The process of claims 1 or 2 wherein the oxygen-containing gas is air.

10. The process of claims 1 or 2 wherein the oxygen-containing gas is added to mixture of crude or distillate and high neutralization crude at temperatures from ambient to 700° C., pressures from atmospheric to 34576 kPa (5000 psig), and treat gas rates up to 534 m3/m3 (3000 scf/B).

11. The process of claims 2 or 3 wherein the oil soluble metal catalyst include metals from Groups 4-12.

12. The process of claim 11 wherein the metal include at least one of V, Cr, Mo, W, Fe, Ni, Co, Pt, Pd, Ru and Mn.

13. The process of claim 3 wherein the peroxide is at least one of hydrogen peroxide, inorganic peroxide or organic peroxide.

14. The process of claims 1, 2 or 3 wherein the solvent includes at least one of sulfolane, furfural, phenol, and N-methyl pyrrolidone.
